(19) United States
(12) Patent Application Publication
(10) Pub. No.: US 2026/0050125 A1
(43) Pub. Date: Feb. 19, 2026

(54) INTERLOCKED N-BY-N WAVELENGTH SELECTIVE SWITCH

(71) Applicant: II-VI Delaware, Inc., Wilmington, DE (US)

(72) Inventors: Helen Chen, Cupertino, CA (US); Xuewen Lu, San Jose, CA (US); Haiji Jimmy Yuan, Cupertino, CA (US); Qingyu Li, Cupertino, CA (US)

(21) Appl. No.: 18/808,346

(22) Filed: Aug. 19, 2024

(51) Int. Cl. G02B 6/293; G02B 6/35; H04J 14/02

(52) U.S. Cl. CPC G02B 6/29383; G02B 6/29308; G02B 6/3546; G02B 6/3518; H04J 14/0212

(57) ABSTRACT

An interlocked N×N wavelength selective switch (WSS) that includes an Express In port, an Express Out port, a passive optical system, an array of switching elements, and N pairs of add and drop ports. In each pair, the add port and the corresponding drop port are arranged relative to the Express In port and the Express Out port such that signals can be simultaneously reflected, by the same switching element via the passive optical system, both from the add port to the Express Out port and from the Express In port to the corresponding drop port, enabling the interlocked N×N WSS to simultaneously add and drop signals in the same wavelength band without the need for two twin 1×N WSSs or an active element (e.g., an N-element MEMS switch array) between the switching array and the ports.

### CROSS-REFERENCE TO RELATED APPLICATIONS

None

### BACKGROUND

Conventional optical add-drop multiplexers (OADMs) are generally realized using either twin 1×N wavelength selective switches (WSS) (i.e., a “drop” WSS and an “add” WSS) or an M×N WSS having M switch windows and an N-element micro-electromechanical system (MEMS) switch array.

Using twin WSSs introduces significant connection loss and switch loss, thereby requiring the use of amplifiers and a pump to amplify the unintentionally attenuated signals, increased electrical power to provide that amplification, and additional electrical power management to manage that increased electrical power.

Meanwhile, the N-element MEMS switch array used by conventional M×N WSS modules makes those modules more complex, bulky, and costly, with inherently higher insertion loss due to the multistep couplings inside the module.

The subject matter of the present disclosure is directed to overcoming, or at least reducing the effects of, one or more problems set forth above.

### SUMMARY

An interlocked N×N wavelength selective switch (WSS) that includes an Express In port, an Express Out port, a passive optical system, an array of switching elements, and N pairs of add and drop ports. In each pair, the add port and the corresponding drop port are arranged relative to the Express In port and the Express Out port such that signals can be simultaneously reflected, by the same switching element via the passive optical system, both from the add port to the Express Out port and from the Express In port to the corresponding drop port, enabling the interlocked N×N WSS to simultaneously add and drop signals in the same wavelength band without the need for two twin 1×N WSSs or an active element (e.g., an N-element MEMS switch array) between the switching array and the ports.

By eliminating the need to use twin conventional 1×N WSSs, embodiments of the interlocked N×N WSS can be provided in simpler, more compact packages than conventional optical add drop multiplexers (OADMs) that introduce as little as half the insertion loss and switch loss (e.g., as low as a single 1×N WSS) as compared to conventional OADMs. Additionally, by eliminating the need for an active component between the optical array and the switching elements (such as the N-element MEMS switch array used in conventional M×N WSS modules), embodiments of the interlocked N×N WSS are much simpler and lower cost (while introducing less insertion loss) compared to conventional M×N WSS modules.

In embodiments, the ports of the interlocked N×N WSS may be substantially aligned along an axis of displacement (e.g., orthogonal to an axis of emission) and the switching elements may be configured to reflect the diffracted optical signals and displace the reflected optical signals along the axis of displacement. In those embodiments, for instance, the add port and drop port of each add-drop pair may be arranged along the axis of displacement such that an angular difference between the diffracted beams output by the passive optical system received from the Express In port and the add port is equal to an angular difference between the reflected beams, reflected by any of the switching elements, that are output by the passive optical system to the Express In port and the corresponding drop port.

In embodiments, each switching element may be configured such that, in one state, the switching element is configured to reflect diffracted optical signals received from the Express In port (via the passive optical system) to the Express Out port (via the passive optical system) and, when in another state, the switching element is configured to simultaneously reflect diffracted optical signals received (via the passive optical system) from the add port of one of the N add-drop pairs to the Express Out port (via the passive optical system) and reflect diffracted optical signals received (via the passive optical system) from the Express In port to the corresponding drop port of the add-drop pair (via the passive optical system). For example, each switching element may have N+1 potential states where the switching element is configured to either pass signals from the Express In port to the Express Out port or simultaneously add and drop signals from and to one of the N add-drop pairs.

In some embodiments, the interlocked N×N WSS may include a controller configured to selectively pass signals from the Express In port to the Express Out port or simultaneously add and drop signals (for example, by setting the state of one or more of the switching elements). In some embodiments, the passive optical system includes a dispersive element that separates the input optical signals into diffracted optical signals in a plurality of wavelength bands, each switching element receives and reflects the diffracted optical signals in one of the plurality of wavelength bands, and the controller is configured to selectively pass or add and drop signals in each wavelength band by controlling the state the switching element that receives the diffracted optical signals in each wavelength band.

In some embodiments, the interlocked N×N WSS is configured to add signals in a wavelength band received via the add port of one of the N add drop pairs and drop signals in that wavelength band (received via the Express In port) to the corresponding drop port of the add-drop pair. In some of those embodiments, for instance, the signals in that wavelength band (received via both the add port and the Express In port) may be diffracted to and reflected by the same switching element.

### BRIEF DESCRIPTION OF THE DRAWINGS

Aspects of exemplary embodiments may be better understood with reference to the accompanying drawings. The components in the drawings are not necessarily to scale, emphasis instead being placed upon illustrating the principles of exemplary embodiments.

FIG. 1A is a simplified block diagram of a conventional 1×N wavelength selective switch (WSS).

FIG. 1B is an orthogonal view of the conventional 1×N WSS of FIG. 1A.

FIG. 1C is another view of the conventional 1×N WSS of FIG. 1A.

FIG. 1D is another view of the conventional 1×N WSS of FIG. 1A.

FIG. 1E is another view of the conventional 1×N WSS of FIG. 1A.

FIG. 2A is a block diagram of a conventional optical add-drop multiplexer (OADM).

FIG. 2B is another diagram of the conventional add-drop OADM of FIG. 2A.

FIG. 2C is another diagram of the conventional add-drop OADM of FIG. 2A.

FIG. 2D is another diagram of the conventional add-drop OADM of FIG. 2A.

FIG. 2E is another diagram of the conventional add-drop OADM of FIG. 2A.

FIG. 2F is another diagram of the conventional add-drop OADM of FIG. 2A.

FIG. 2G is another diagram of the conventional add-drop OADM of FIG. 2A.

FIG. 2H is another diagram of the conventional add-drop OADM of FIG. 2A.

FIG. 3A is a block diagram of an interlocked N×N WSS according to exemplary embodiments.

FIG. 3B is another diagram of the interlocked N×N WSS according to exemplary embodiments.

FIG. 3C is another diagram of the interlocked N×N WSS according to exemplary embodiments.

FIG. 3D is another diagram of the interlocked N×N WSS according to exemplary embodiments.

FIG. 3E is another diagram of the interlocked N×N WSS according to exemplary embodiments.

FIG. 3F is another diagram of the interlocked N×N WSS according to exemplary embodiments.

FIG. 3G is another diagram of the interlocked N×N WSS according to exemplary embodiments.

FIG. 3H is another diagram of the interlocked N×N WSS according to exemplary embodiments.

FIG. 3I is another diagram of the interlocked N×N WSS according to exemplary embodiments.

FIG. 3J is another diagram of the interlocked N×N WSS according to exemplary embodiments.

FIG. 3K is another diagram of the interlocked N×N WSS according to exemplary embodiments.

### DETAILED DESCRIPTION

Reference to the drawings illustrating various views of exemplary embodiments is now made. In the drawings and the description of the drawings herein, certain terminology is used for convenience only and is not to be taken as limiting the embodiments of the present invention. Furthermore, in the drawings and the description below, like numerals indicate like elements throughout.

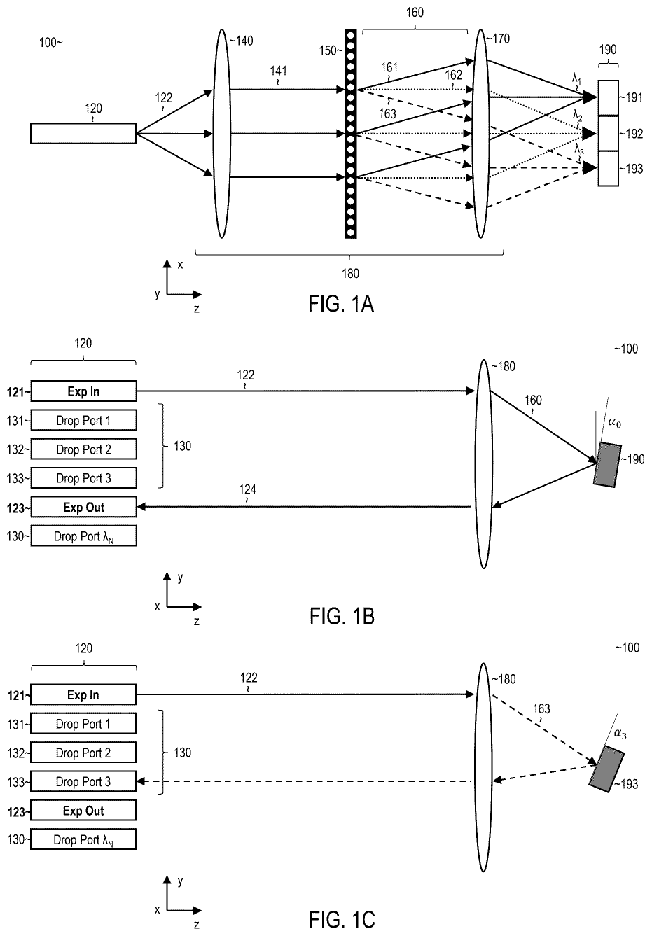

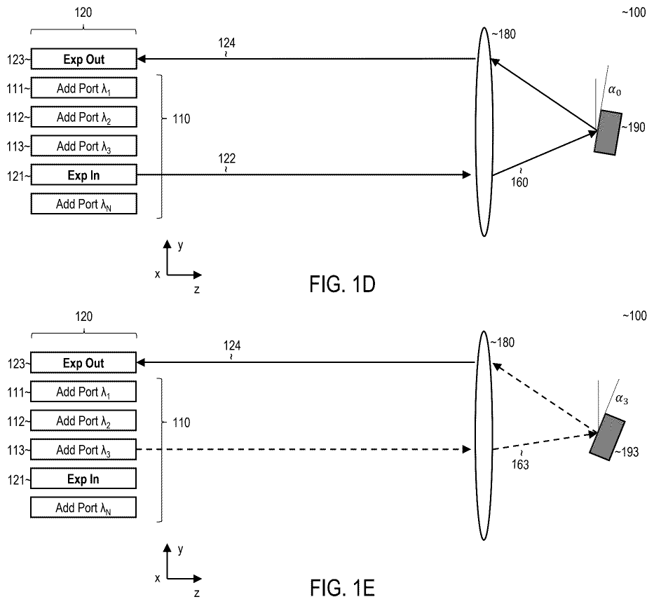

FIG. 1A is a simplified block diagram of a conventional 1×N wavelength selective switch (WSS) 100. In the example of FIG. 1A, the WSS 100 includes an optical array 120, collimation optics 140, a dispersive element 150, focusing optics 170, and an array of switching elements 190. The collimation optics 140, the dispersive element 150, the focusing optics 170 are collectively referred to below as passive optical system 180.

As described in more detail below, the WSS 100 can be used as either an “add” WSS or a “drop” WSS. When used as a drop WSS, one port of the optical array 120 is used as an input port (generally referred to as the “Express In” port) while the remaining ports are used as output ports (an “Express Out” port and a number of drop ports). Alternatively, when the WSS 100 is used as an add WSS, one of the ports is used as an output port (the “Express Out” port) while the remaining ports of the optical array 120 are used as input ports (the “Express In” port and a number of add ports).

When used as input ports, each port of the optical array 120 emits an input optical signal 122 along an axis of emission (arbitrarily identified in FIGS. 1A-1E as the ‘z’ axis). The collimation optics 140 collimates the input optical signals 122 to form collimated optical signals 141, which are passed to the dispersive element 150. The dispersive element 150 diffracts the collimated optical signals 141 according to wavelength to form a number of diffracted beams 160 that are each within a wavelength band. In the example of FIG. 1A, for instance, the diffracted beams 160 include diffracted beams 161 within the wavelength band λ₁, diffracted beams 162 within the wavelength band λ₂, and diffracted beams 163 within the wavelength band λ₃. The focusing optics 170 then focuses each of the diffracted beams 160 onto one of the switching elements 190.

Each switching element 190 receives diffracted beams 160 within one of the wavelength bands. In the example of FIG. 1A, for instance, the switching elements 190 include a first switching element 191 that receives the diffracted beams 161 within the wavelength band λ₁, a second switching element 192 that receives the diffracted beams 162 within the wavelength band λ₂, and a third switching element 193 that receives the diffracted beams 163 within the wavelength band λ₃. The switching elements 190 can then be used to selectively control each wavelength band of the input optical signals 122 as described below with reference to FIGS. 1B-1E.

FIGS. 1B-1E are orthogonal views of the example WSS 100. Individual components of the passive optical system 180 are omitted for clarity. In the example of FIGS. 1A-1E, the ports of the optical array 120 are arranged orthogonal to the axis of emission (the ‘z’ axis in FIGS. 1A-1E) along an axis referred to herein as the “axis of displacement” (arbitrarily identified in FIGS. 1A-1E as the ‘y’ axis). The switching elements 190 reflect the diffracted beams 160 for transmittal back to optical array 120 via the passive optical system 180. Meanwhile, as described below, the switching elements 190 may be used to selectively control each wavelength band by selectively displacing each wavelength band along the axis of displacement (the ‘y’ axis in FIGS. 1A-1E).

FIGS. 1B-1C illustrate use of the WSS 100 as a drop WSS. When used as a drop WSS as shown in FIGS. 1B-1C, the optical array 120 includes an Express In port 121, an Express Out port 123 and a number of drop ports 131, 132, 133, etc. (generically and collectively referred to herein as one or more drop ports 130). The switching elements 190 can then be used to selectively pass or drop signals according to wavelength.

Each switching element 190 can be placed in one of at least two states, referred to herein as a pass state α₀ and at least one drop state α_{N}. Each switching element 190 reflects the diffracted beams 160 by an angle that is dependent on the state α of that switching element 190. As shown in FIG. 1B, for instance, a switching element 190 can be used to pass the diffracted beams 160 received by that switching element 190 to the Express Out port 123 by placing that switching element into the pass state α₀ wherein the diffracted beams 160 received by that switching element 190 from the Express In port 121 are reflected to the Express Out port 123 via the passive optical system 180. The passive optical system 180 combines all of the diffracted beams 160 reflected to the Express Out port 123 by each switching element 190 to form output optical signals 124, which are provided to and output by the Express Out port 123.

Each switching element 190 can drop the diffracted beams 160 received by that switching element 190 by being placed into a drop state α_{N} wherein the diffracted beams 160 received by that switching element 190 from the Express In port 121 are reflected to one of the drop ports 130. In a drop WSS having N drop ports 130, each switching element 190 may be configured such that it can be placed in any of N drop states α_{N}, where each of the N drop states α_{N} corresponds to one of the N drop ports 130. In the example of FIG. 1C, for instance, the switching element 193 can selectively drop the diffracted beams 163 received by the switching element 193 by being placed in the state α₃ wherein the diffracted beams 163 received by that switching element 193 from the Express In port 121 are reflected to the drop ports 133.

FIGS. 1D-1E illustrate use of the WSS 100 as an add WSS. When used as an add WSS as shown in FIGS. 1D-1E, the optical array 120 includes an Express Out port 123, an Express In port 121, and a number of add ports 111, 112, 113, etc. (generically and collectively referred to herein as one or more add ports 110). Just like the add WSS example described above, signals from the optical array 120 are diffracted to each switching element 190 according to wavelength band. Each switching element 190 can then be used to reflect the diffracted beams 160 within that wavelength band to the Express Out port 123.

In an add WSS, however, each switching element 190 is used to reflect the diffracted beams 160 either from the Express In port 121 (e.g., as shown in FIG. 1D) or from one the add ports 110 (e.g., the diffracted beam 163 from the add port 113 as shown in FIG. 1E). Similar to the drop WSS example above, each switching element 190 may be configured such that it can be placed in either a pass state α₀ (wherein diffracted beams 160 are reflected to the Express Out port 123 from the Express In port 121) or one more add states α_{N} (wherein diffracted beams 160 are reflected to the Express Out port 123 from one of the add ports 110).

Theoretically, any switching element 190 can be used to reflect signals between any two ports of the optical array 120. In practice, however, optical add-drop multiplexers (OADMs) are often used to simultaneously add and drop signals in the same wavelength band. Meanwhile, in the conventional 1×N WSS 100 of FIGS. 1A-1E, all signals within each wavelength band (from any/all ports of the optical array 120) are diffracted to the same switching element 190 (as shown in FIG. 1A), which can only be in one state α at any given time (as shown in FIGS. 1B-1E). Accordingly, optical add-drop multiplexers are often formed using two twin conventional 1×N wavelength WSSs 100.

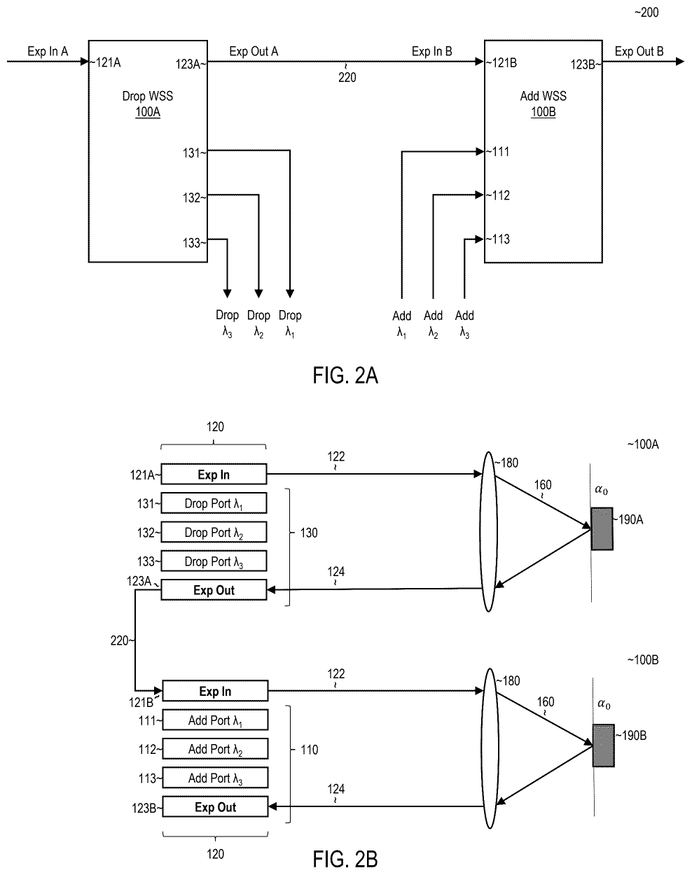

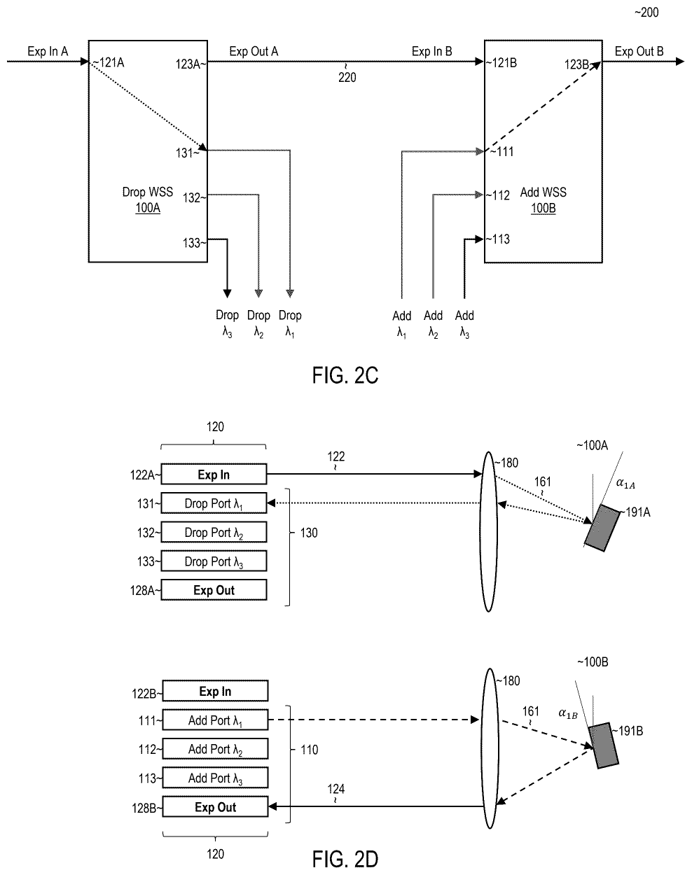

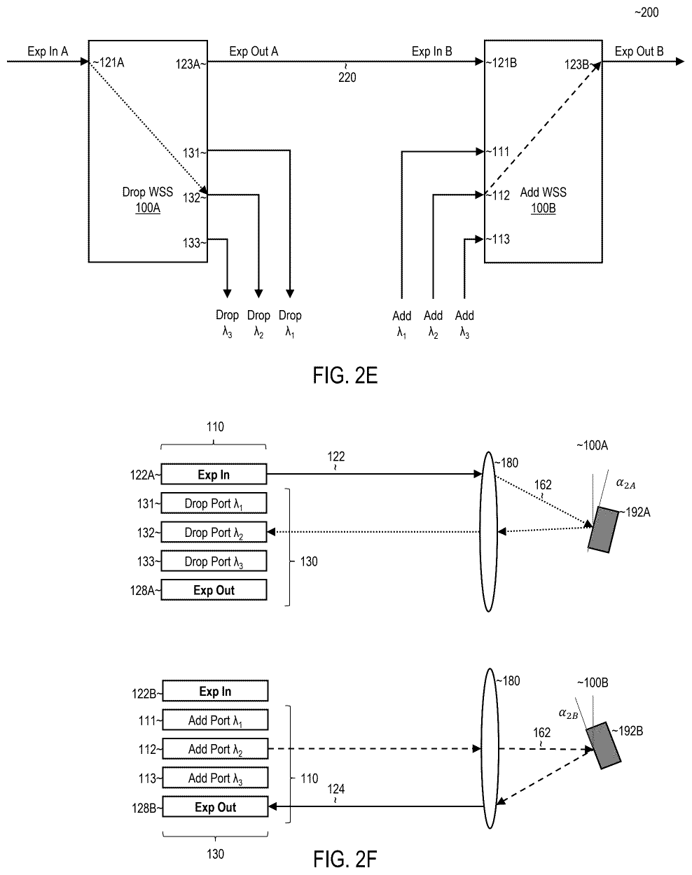

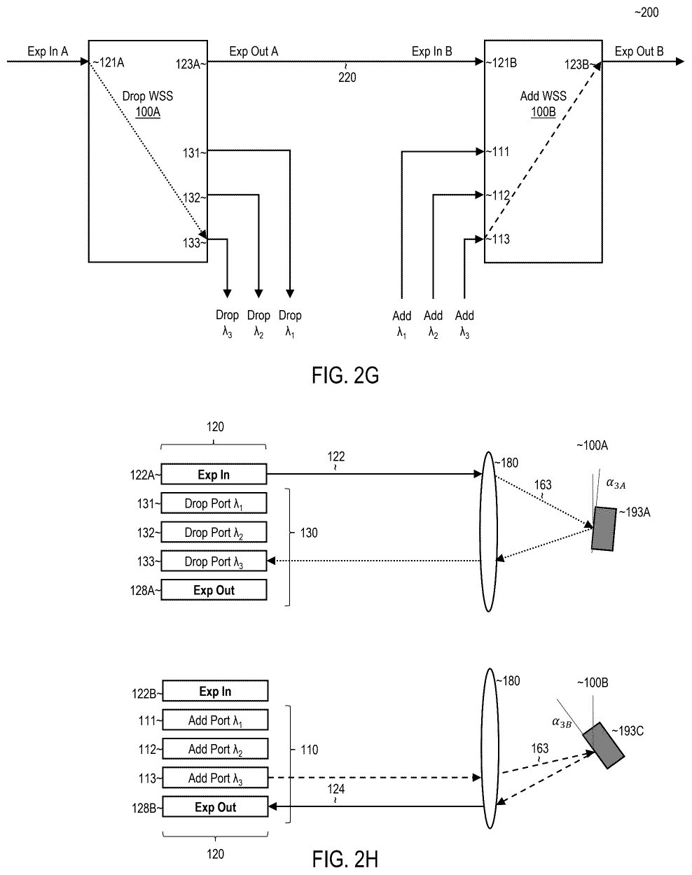

FIGS. 2A-2H are diagrams of a conventional OADM 200 that includes twin 1×N wavelength selective switches 100 - a drop WSS 100A and an add WSS 100B—connected via an optical link 220. In the example of FIGS. 2A-2H, the drop WSS 100A includes an Express In port 121A, an Express Out port 123A, and a number of drop ports 130; the add WSS 100B includes an Express In port 121B, an Express Out port 123B, and a number of add ports 110; and the Express Out port 123A of the drop WSS 100A is connected to the Express In port 121B of the drop WSS 100B via the optical link 220.

FIG. 2B illustrates an example of the conventional OADM 200 passing signals (i.e., under circumstances in which signals in that wavelength band are not being dropped and/or added). As shown in FIG. 2B, the conventional OADM 200 passes signals by first reflecting them from the Express In port 121A of the drop WSS 100A to the Express Out port 123A using a switching element 190A of the drop WSS 100A, passing them from the Express Out port 123A of the drop WSS 100A to the Express In port 121B of the drop WSS 100B via the optical link 220, and then reflecting those signals from the Express In port 121B of the add WSS 100B to the Express Out port 123B of the add WSS 100B using a switching element 190B of the add WSS 100B.

As shown in FIGS. 2C-2D, signals in a wavelength band λ₁ (that are diffracted to switching elements 191A and 191B as described above) may be simultaneously dropped to the drop port 131 by the drop WSS 100A and added from the add port 111 by add WSS 100B.

Similarly, as shown in FIGS. 2E-2F, signals in a wavelength band λ₂ may be simultaneously dropped to the drop port 132 by the switching element 192A of the drop WSS 100A and added from the add port 112 by the switching element 192B of the add WSS 100B. Finally, as shown in FIGS. 2G-2H, signals in a wavelength band λ₃ may be simultaneously dropped to the drop port 133 by the switching element 193A of the drop WSS 100A and added from the add port 113 by the switching element 193B of the add WSS 100B.

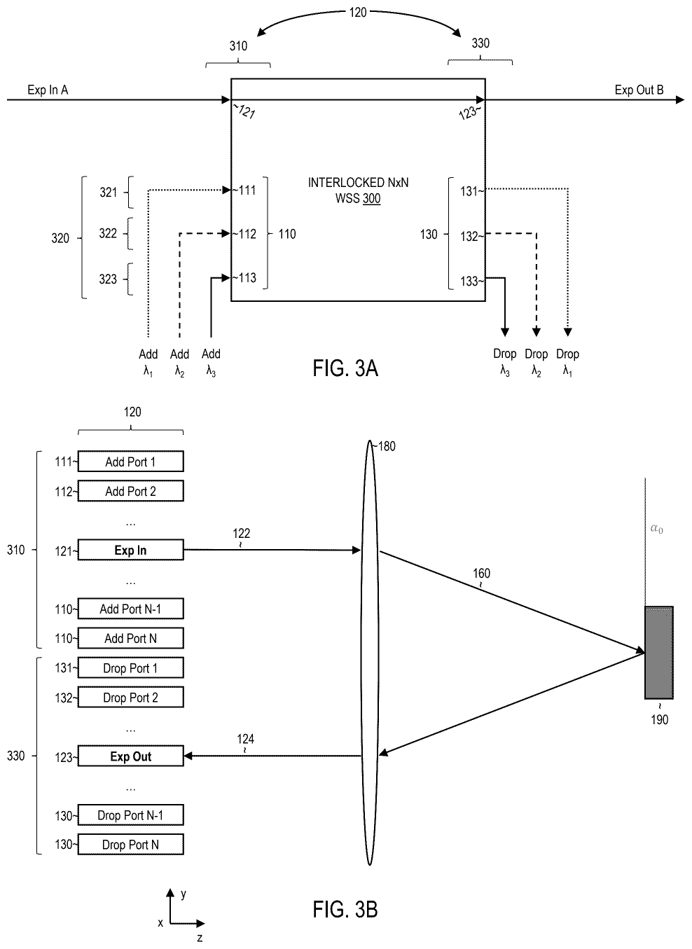

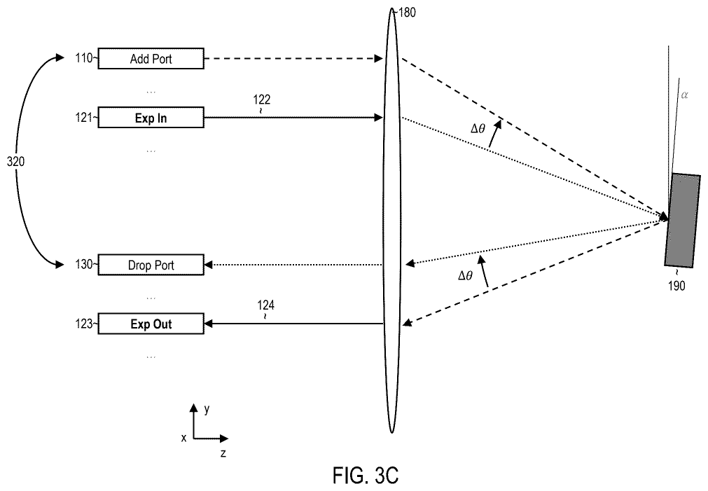

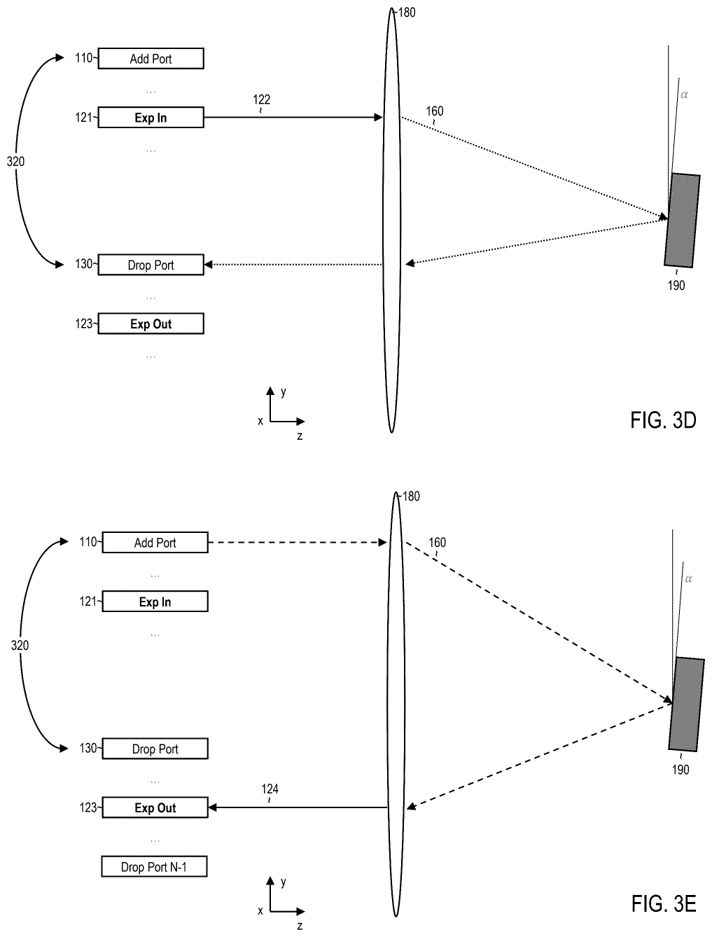

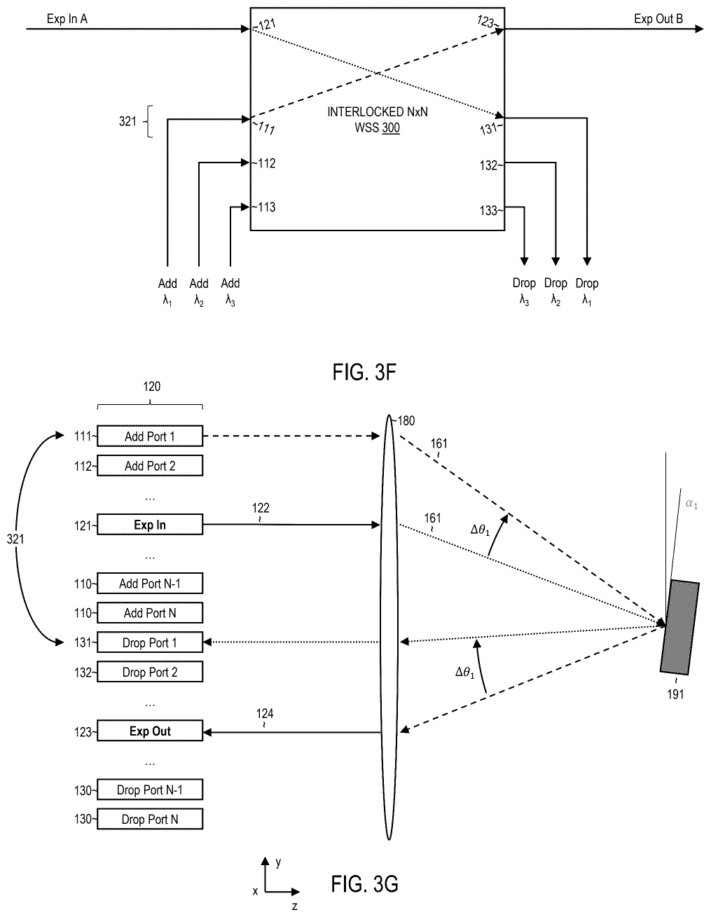

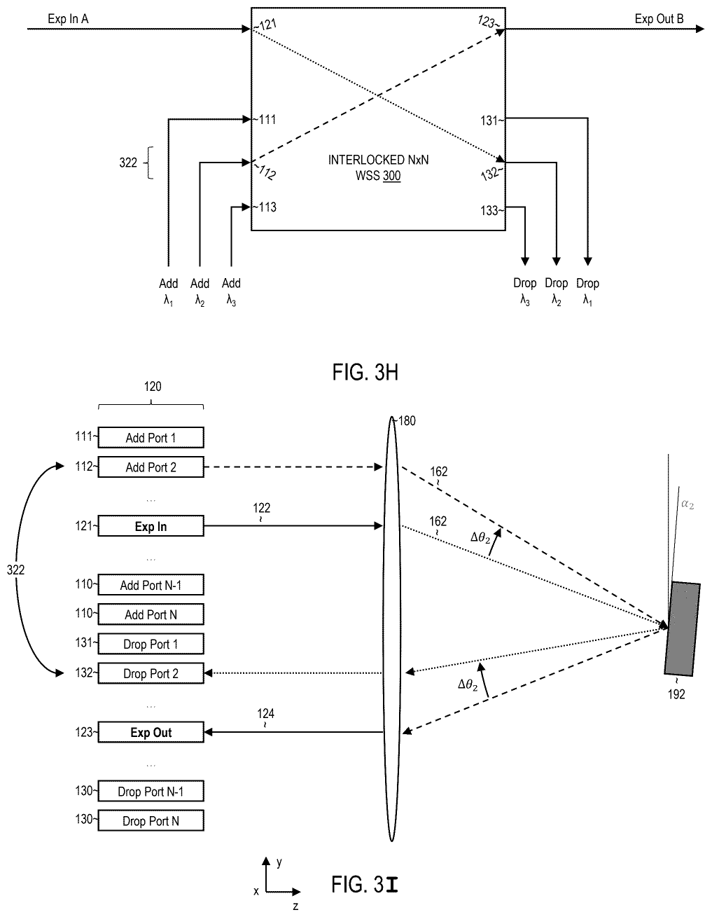

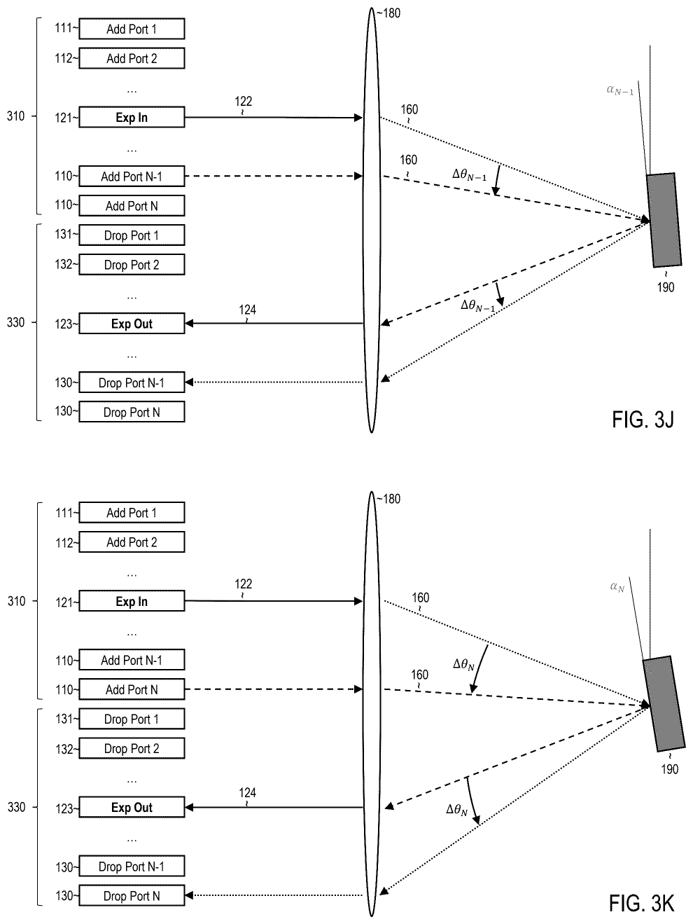

FIGS. 3A-3H are diagrams illustrating an interlocked N×N wavelength selective switch (WSS) 300 according to exemplary embodiments.

In the embodiments of FIGS. 3A-3H, the interlocked WSS 300 includes an optical array 120 that includes both an optical input array 310 and an optical output array 330. The optical input array 310 includes an Express In port 121 and N add ports 110. The optical output array 330 includes an Express Out port 123 and N drop ports 130. The add ports 110 and the drop ports 130 form N add-drop pairs 320, each add-drop pair including an add port 110 and an associated drop port 130.

Unlike the conventional 1×N WSS 100 described above, the interlocked N×N WSS 300 is capable of simultaneously adding and dropping signals in the same wavelength band using only one array of switching elements 190 as described below, eliminating the need to use two twin 1×N WSSs (or a MEMS switch array), reducing connection loss and switch loss, and providing a number of benefits outlined below.

As shown in FIG. 3B, the interlocked N×N WSS 300 can be used to pass signals in any wavelength band by reflecting them, using the switching element 190 that receives the diffracted beams 160 within that wavelength band from the passive optical system 180, from the Express In port 121 to the Express Out port 123. The passive optical system 180 is then configured to combine all of the diffracted beams 160 reflected to the Express Out port 123 by each switching element 190 to form output optical signals 124, which are provided to and output by the Express Out port 123.

Additionally, as shown in FIGS. 3C-3K, the interlocked N×N WSS 300 is capable of simultaneously adding and dropping signals in the same wavelength band because the add ports 110 and the drop ports 130 form N add-drop pairs 320 that are arranged relative to the Express In port 121 and the Express Out port 123 along the axis of displacement (the ‘y’ axis in FIGS. 3B-3E, etc.) such that signals can be simultaneously reflected by a single switching element 190 from the Express In port 121 to the drop port 130 and from the corresponding add port 110 to the Express Out port 123. As shown more specifically in FIGS. 3C-3E, each add port 110 and drop port 130 of each add-drop pair 320 are arranged along the axis of displacement such that the angular difference Δθ between the diffracted beams 161 received (via the passive optical system 180) from Express In port 121 and the add port 110 is the same as the angular difference Δθ between the reflected beams output (via the passive optical system 180) to the Express Out port 121 and the corresponding drop port 130. Accordingly, a single switching element 190 in a state α can simultaneously reflect the diffracted beams 160 received by that switching element 190 both from the Express In port 121 to the drop port 130 as shown in FIG. 3D and from the corresponding add port 110 of the add-drop pair 320 to the Express Out port 123 as shown in FIG. 3E.

Therefore, unlike the conventional 1×N WSS 100 described above, the interlocked N×N WSS 300 provides functionality to simultaneously add and drop signals in the same wavelength band, even though they are diffracted to the same switching element 190 as described above. As shown in FIGS. 3F-3G, for instance, the add port 111 and the drop port 131 may form an add drop pair 321, which may be used to simultaneously add and drop signals in a first wavelength band λ₁ that are diffracted to a first switching element 191. The first switching element 191 can then be used to simultaneously add and drop signals in the first wavelength band λ₁ by moving to the state (α₁ in FIG. 3G) whereby the diffracted beams 161 are reflected both from the Express In port 121 to the drop port 131 and from the corresponding add port 111 to the Express Out port 123. Meanwhile, just like the conventional OADM 200, the first switching element 191 provides functionality to pass the signals in the first wavelength band λ₁ by moving to the state (α₀ in FIG. 3B) whereby the diffracted beams 161 are reflected from the Express In port 121 to the Express Out port 123.

Similarly, as shown in FIGS. 3H-3I, the add port 112 and the drop port 132 may form an add drop pair 322, which may be used to selectively add and drop signals in a second wavelength band λ₂ that are diffracted to a second switching element 192 by moving the second switching element 192 to the state (α₂ in FIG. 3I) whereby the diffracted beams 162 are reflected both from the Express In port 121 to the drop port 132 and from the corresponding add port 112 to the Express Out port 123. Finally, as shown in FIGS. 3J and 3K, the N add ports 110 and the N drop ports 130 may form N add-drop pairs 320 wherein the add port 110 and the corresponding drop port 130 are arranged at the same angular distance Δθ relative to the Express In port 121 or the Express Out port 132 such that one of the N switching elements (in a state α_{N}) can simultaneously reflect diffracted beams 160 both from the Express In port 121 to the drop port 130 and from the corresponding add port 110 to the Express Out port 123.

As one of ordinary skill in the art would recognize based on the disclosure, each add-drop pair 320 can use any number of switching elements 190 to simultaneously add and drop signals in any number of wavelength bands, each of which may include any number of wavelength channels. Meanwhile, because their symmetrical arrangement along the axis of displacement relative to the Express In port 121 and the Express Out port 123, each add-drop pair 320 can be used to simultaneously add and drop signals in the same wavelength band or bands. Accordingly, to add and drop signals in a wavelength band, all of the signals to be added in that wavelength band may be provided to one of the add ports 110 of the interlocked N×N WSS 300, which may then be used to drop the signals in that wavelength band to the corresponding drop port 130.

By eliminating the need to use twin conventional 1×N WSSs (e.g., as shown in FIGS. 1A-1E), embodiments of the interlocked N×N WSS 300 can be provided in simpler, more compact packages than conventional OADMs (e.g., as shown FIGS. 2A-2H). Meanwhile, the insertion loss and switch loss introduced by embodiments of the interlocked N×N WSS 300 may be as low as a single 1×N WSS. Accordingly, relative to conventional OADMs that use twin conventional 1×N WSSs, embodiments of the N×N WSS 300 may reduce connection loss and switch loss by approximately 50 percent (reducing insertion loss, for example, by approximately 6 decibels along the express path). As a result, embodiments of the interlocked N×N WSS 300 may reduce the number of the amplifiers required to amplify unintentionally attenuated signals, the material cost to produce those amplifiers, the electrical power consumed by those amplifiers and a pump to provide that amplification.

Arranging each add port 110 and drop port 130 of each add-drop pair 320 as described above also enables embodiments of the interlocked N×N WSS 300 to simultaneously reflect signals to two ports using a passive optical system 180, eliminating the need for an active component (such as the N-element MEMS switch array used in conventional M×N WSS modules) between the optical array 120 and the switching elements 190. Accordingly, embodiments of the interlocked N×N WSS 300 are much simpler and lower cost compared to conventional M×N WSS modules while introducing less insertion loss (e.g., as low as a single 1×N WSS).

The passive optical system 180 may include any number of optical elements suitably capable of diffracting and providing optical signals from the optical input array 310 to the optical output array 330 via the switching elements 190 as described above. As described above with reference to FIG. 1A, for example, the passive optical system 180 may optionally include collimation optics 140, one or more dispersive elements 150, and focusing optics 170. Additionally, the passive optical system 180 may include, for example, polarization diversity optics, compensating optics, one or more mirrors, etc.

In some embodiments, the optical array 120 and the array of switching elements 190 may be aligned (e.g., as shown in FIG. 1A) along an axis of emission (the ‘z’ axis in FIG. 1A). In those embodiments, the dispersive element 150 may diffract each of the collimated optical signals 141 along an axis of diffraction (arbitrarily identified as the ‘x’ axis in in FIGS. 1A-1E) that is orthogonal to both an axis of displacement (the ‘y’ axis in in FIGS. 1A-1E) and the axis of emission (the ‘z’ axis in in FIGS. 1A-1E). In other embodiments, however, the optical array 120 and the array of switching elements 190 may not be aligned along the axis of emission and the passive optical system 180 may include one or more passive reflective elements that reflect, refract, diffract, or otherwise guide the optical signals between the optical array 120 and the array of switching elements 190.

In the example embodiments shown in FIGS. 3A-3K, the ports of the optical array 120 are substantially aligned along an axis of displacement (e.g., the ‘y’ axis in FIGS. 3B-3E, etc.) and the switching elements 190 displace the reflected optical signals along that axis of displacement prior to transmittal via the passive optical system 180. As one of ordinary skill in the art would recognize based on the disclosure, however, the passive optical system 180 may include any number of passive elements that reflect, refract, diffract, guide, or otherwise change the trajectory of the optical signals. Accordingly, as used herein, displacing the reflected optical signals along that axis of displacement means reflecting those optical signals such that they are displaced along the axis of displacement at the optical array 120 (i.e., reflected such that they are provided to the intended port after transmittal via the passive optical system 180).

Because the switching elements 190 bidirectionally reflect signals, the terms “input” and “output” are used arbitrarily herein. Accordingly, the optical input array 310 and the optical input array 310 can be used interchangeably depending on implementation. Similarly, either of the two ports in each add-drop pairs 320 can be used as the add port 110 or the drop port 130 depending on the implementation as long as the angular difference Δθ between the diffracted beams 161 received (via the passive optical system 180) from Express In port 121 and the add port 110 is the same as the angular difference Δθ between the reflected beams output (via the passive optical system 180) to the Express Out port 121 and the corresponding drop port 130.

Each port the optical array 120 may be realized as any hardware element suitably capable of outputting and/or receiving an optical signal. For example, each port may be an optical fiber, an optical waveguide, etc. The interlocked N×N WSS 300 includes N add-drop pairs 320. In various embodiments, the number of add-drop pairs N may be any integer greater than 0.

The switching elements 190 may be realized as any hardware element suitably capable of reflecting optical signals as described above. For example, the array of switching elements 190 may be realized as a liquid crystal on silicon (LCoS) switch engine—a solid-state display engine forms an electrically-programmable grating by controlling the phase of light at each pixel. In those embodiments, each switching element 190 may be realized as portion of display area, which can be placed in a state α by controlling the grating formed in that portion of the display area. In another example, the array of switching elements 190 may be a MEMS switching engine. In those embodiments, each switching element 190 may be realized as a micromirror that tilts due to electrostatic attraction, which can be placed into a state α by applying a voltage to an electrode. In another example, the array of switching elements 190 may be realized as a liquid crystal (LC) switching engine where each switching element 190 is realized as a liquid crystal cell that selectively controls the polarization state of transmitted light in accordance with an applied voltage. In those embodiments, the array of switching elements 190 (or the passive optical system 180) may also include a polarization dependent optical element (e.g., a polarization beam splitter) that changes the path of the transmitted light based on polarization and each switching element 190 may be placed into a state α by applying a voltage associated with that state α. In another example, the array of switching elements 190 may be realized as an optical switch engine with liquid crystals and birefringent wedges, for example as described in U.S. Pat. No. 7,492,986.

The interlocked N×N WSS 300 may include a controller that controls the state α of each switching element 190 to selectively either pass signals from the Express In port 121 to the Express Out port 123 (e.g., as shown in FIG. 3B) or simultaneously add signals from one of the add port 130 and drop signals to the corresponding drop port 130 (e.g., as shown in FIGS. 3C-3K). The controller may include any hardware element (e.g., a hardware processor, a state machine, etc.) suitably capable of controlling each of the switching elements 190.

While preferred embodiments have been described above, those skilled in the art who have reviewed the present disclosure will readily appreciate that other embodiments can be realized within the scope of the invention. Accordingly, the present invention should be construed as limited only by any appended claims.

What is claimed is:

1. An interlocked N×N wavelength selective switch (WSS), comprising:
an optical input array configured to receive input optical signals, the optical input array comprising an express in port and N add ports;
an optical output array comprising an express out port and N drop ports, the N drop ports and the N add ports forming N add-drop pairs, each of the N add-drop pairs including an add port of the N add ports and a corresponding drop port of the N drop ports;
an array of switching elements; and
a passive optical system configured to diffract the input optical signals to form diffracted optical signals, focus the diffracted optical signals onto the array of switching elements, receive reflected optical signals from the array of switching elements, and focus the reflected optical signals onto the optical output array,
wherein the add port and the corresponding drop port of each add-drop pair are arranged relative to the express in port and the express out port such that input optical signals can be simultaneously reflected, by one of the switching elements via the passive optical system, both from the add port to the express out port and from the express in port to the corresponding drop port.

2. The WSS of claim 1, wherein:
the express in port, the N add ports, the express out port, and the N drop ports are substantially aligned along an axis of displacement;
the optical input array emits the input optical signals along an axis of emission that is orthogonal to the axis of displacement; and
the switching elements are configured to reflect the diffracted optical signals and displace the reflected optical signals along the axis of displacement.

3. The WSS of claim 2, wherein the add port and the corresponding drop port of each of the N add-drop pairs are arranged along the axis of displacement such that an angular difference between the diffracted beams output by the passive optical system received from the express in port and the add port is equal to an angular difference between the reflected beams, reflected by any of the switching elements, that are output by the passive optical system to the express in port and the corresponding drop port.

4. The WSS of claim 1, wherein each switching element is configured such that:
in a 0th state, the switching element is configured to reflect diffracted optical signals received from the express in port via the passive optical system to the express out port via the passive optical system; and
in at least one additional state, the switching element is configured to simultaneously:
reflect diffracted optical signals received via the passive optical system from the add port of one of the N add-drop pairs to the express out port via the passive optical system; and
reflect diffracted optical signals received via the passive optical system from the express in port to the corresponding drop port of the add-drop pair via the passive optical system.

5. The WSS of claim 4, wherein the at least one additional state comprises N additional states, each of the N additional states corresponding to one of the N add-drop pairs, wherein the switching element is configured to simultaneously:
reflect diffracted optical signals received via the passive optical system from the add port of the corresponding add-drop pair to the express out port via the passive optical system; and
reflect diffracted optical signals received via the passive optical system from the express in port to the drop port of the corresponding add-drop pair via the passive optical system.

6. The WSS of claim 5, further comprising:
a controller configured to selectively pass signals from the express in port to the express out port or simultaneously add and drop signals by changing the state of one or more of the switching elements.

7. The WSS of claim 6, wherein:
the passive optical system includes a dispersive element that separates the input optical signals into diffracted optical signals in a plurality of wavelength bands;
each switching element receives and reflects the diffracted optical signals in one of the plurality of wavelength bands; and
the controller is configured to selectively pass or add and drop signals in each wavelength band by controlling the state the switching element that receives the diffracted optical signals in each wavelength band.

8. The WSS of claim 1, wherein the WSS is configured to:
add signals in a wavelength band received via the add port of one of the N add drop pairs; and
drop signals in the wavelength band, received via the express in port, by outputting the dropped signals via the corresponding drop port of the add-drop pair.

9. The WSS of claim 8, wherein the signals in the wavelength band received via both the add port and the express in port are diffracted to one switching element of the array of switching elements and simultaneously reflected by the one switching element.

10. The WSS of claim 1, wherein the array of switching elements comprises a liquid crystal on silicon (LCoS) switch engine, a micro-electromechanical system (MEMS) switching engine, a liquid crystal (LC) switching engine, or an optical switch engine with liquid crystals and birefringent wedges.

11. A method of selectively passing or simultaneously adding and dropping optical signals according to wavelength, the method comprising:
receiving input optical signals via an optical input array comprising an express in port and N add ports;
providing an optical output array comprising an express out port and N drop ports, the N drop ports and the N add ports forming N add-drop pairs, each of the N add-drop pairs including an add port of the N add ports and a corresponding drop port of the N drop ports;
using a passive system to diffract the input optical signals to form diffracted optical signals and focusing the diffracted optical signals onto an array of switching elements;
controlling the array of switching elements to reflect the diffracted optical signals and form reflected optical signals; and
using the passive optical system to focus the reflected optical signals onto the optical output array,
wherein the add port and the corresponding drop port of each add-drop pair are arranged relative to the express in port and the express out port such that input optical signals can be simultaneously reflected, by one of the switching elements via the passive optical system, both from the add port to the express out port and from the express in port to the corresponding drop port.

12. The method of claim 11, wherein:
the express in port, the N add ports, the express out port, and the N drop ports are substantially aligned along an axis of displacement; and
reflect the diffracted optical signals comprises displacing the reflected optical signals along the axis of displacement.

13. The method of claim 12, wherein the add port and the corresponding drop port of each of the N add-drop pairs are arranged along the axis of displacement such that an angular difference between the diffracted beams output by the passive optical system received from the express in port and the add port is equal to an angular difference between the reflected beams, reflected by any of the switching elements, that are output by the passive optical system to the express in port and the corresponding drop port.

14. The method of claim 11, further comprising:
reflecting, by one of the switching elements while in a 0th state, diffracted optical signals received from the express in port via the passive optical system to the express out port via the passive optical system; and
simultaneously reflecting, by the one switching element while in at least one additional state:
diffracted optical signals received via the passive optical system from the add port of one of the N add-drop pairs to the express out port via the passive optical system; and
diffracted optical signals received via the passive optical system from the express in port to the corresponding drop port of the add-drop pair via the passive optical system.

15. The method of claim 14, wherein each of the switching elements are controllable to be placed in the 0th state or one of N additional states, each of the N additional states corresponding to one of the N add-drop pairs, the method comprising:
simultaneously reflecting, by one of the switching elements while one of the N additional states:
diffracted optical signals received via the passive optical system from the add port of the corresponding add-drop pair to the express out port via the passive optical system; and
diffracted optical signals received via the passive optical system from the express in port to the drop port of the corresponding add-drop pair via the passive optical system.

16. The method of claim 14, further comprising:
selectively passing signals from the express in port to the express out port or simultaneously add and drop signals by controlling the state of one or more of the switching elements.

17. The method of claim 14, further comprising:
using the passive optical system to separate the input optical signals into diffracted optical signals in a plurality of wavelength bands;
providing the diffracted optical signals in each wavelength band to one of the switching elements; and
selectively passing or add and drop signals according to wavelength band by controlling the state the switching element that receives the diffracted optical signals in each wavelength band.

18. The method of claim 11, further comprising:
adding signals in a wavelength band received via the add port of one of the N add drop pairs; and
dropping signals in the wavelength band, received via the express in port, by outputting the dropped signals via the corresponding drop port of the add-drop pair.

19. The method of claim 18, further comprising:
using the passive optical system to diffract the signals in the wavelength band received via both the add port and the express in port to one switching element of the array of switching elements; and
simultaneously reflecting, by the one switching element, the diffracted beams in the wavelength band.

20. A method of making an interlocked N×N wavelength selective switch (WSS), the method comprising:
forming an optical input array comprising an express in port and N add ports;
forming an optical output array comprising an express out port and N drop ports, the N drop ports and the N add ports forming N add-drop pairs, each of the N add-drop pairs including an add port of the N add ports and a corresponding drop port of the N drop ports;
providing an array of switching elements; and
arranging a passive optical system configured to diffract the input optical signals to form diffracted optical signals, focus the diffracted optical signals onto the array of switching elements, receive reflected optical signals from the array of switching elements, and focus the reflected optical signals onto the optical output array,
wherein forming the optical input array forming the optical output array comprises arranging each add port and the corresponding drop port of each add-drop pair, relative to the express in port and the express out port, such that input optical signals can be simultaneously reflected, by one of the switching elements via the passive optical system, both from the add port to the express out port and from the express in port to the corresponding drop port.
